(19) United States
(12) Patent Application Publication
(10) Pub. No.: US 2011/0167949 A1
(43) Pub. Date: Jul. 14, 2011

(54) Moveable brake lever for bicycle

(76) Inventor: Szu-Fang Tsai, Changhua (TW)

(21) Appl. No.: 12/684,112

(22) Filed: Jan. 8, 2010

(51) Int. Cl. F16C 1/22

(52) U.S. Cl. 74/502.2

(57) ABSTRACT

A brake operating device for a bicycle comprising a housing on a handlebar, the housing comprising a recess on a mouth; a spring biased brake lever rotatably mounted on the housing; a brake cable having one end connected to a cable connector of the brake lever; and a spring biased stop member pivotably sitting upon the brake lever to urge against the recess. Pressing the stop member to disengage the stop member from the recess and counterclockwise pivoting the brake lever will loosen the brake cable. Thereafter, a tire replacement is made easy.

### BACKGROUND OF THE INVENTION

1. Field of Invention

The invention relates to bicycle brake mechanisms and more particularly to a moveable brake lever for bicycle for ease of tire replacement.

2. Description of Related Art

Conventionally, for bicycles a brake lever is fixedly rotatably mounted through a pivot on a housing of a handlebar. Also, for increasing brake sensitivity it is typical of decreasing gap between either brake pad and a wheel rim to a minimum as possible. While it can achieve the above goal, it is found that a bicycle mechanic may have difficulties of removing a broken wheel for replacement or repair. Thus, the need for improvement still exists.

There have been numerous suggestions in prior patents for brake lever for bicycle. For example, U.S. Pat. No. 5,279,179 discloses a brake operating device for bicycles.

### SUMMARY OF THE INVENTION

It is therefore one object of the invention to provide a brake operating device for a bicycle, comprising a housing on a handlebar, the housing comprising a recess on a mouth; a spring biased brake lever rotatably mounted on the housing; a brake cable having one end connected to a cable connector of the brake lever; and a spring biased stop member pivotably sitting upon the brake lever to urge against the recess. Pressing the stop member to disengage the stop member from the recess and counterclockwise pivoting the brake lever will loosen the brake cable.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of brake operating device for bicycle according to the invention;

FIG. 2 is a perspective view of the assembled brake operating device;

FIG. 3 is a longitudinal sectional view of the brake operating device shown in FIG. 2; and

FIGS. 4, 5, and 6 are side elevations in part section of the brake operating device shown in FIG. 2 showing steps of loosening a brake cable.

### DETAILED DESCRIPTION OF THE INVENTION

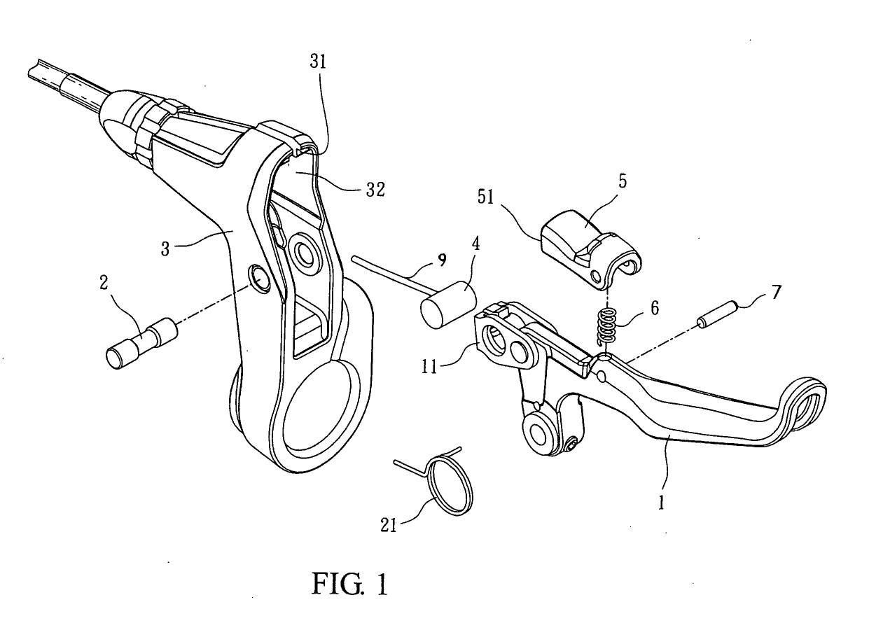

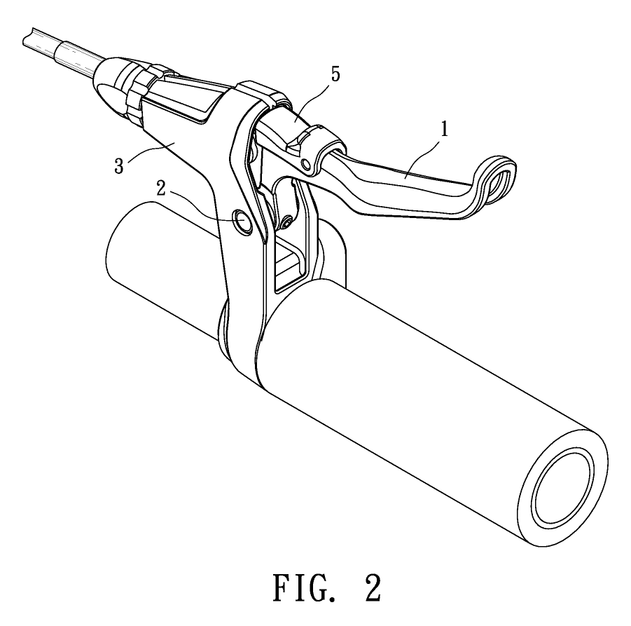

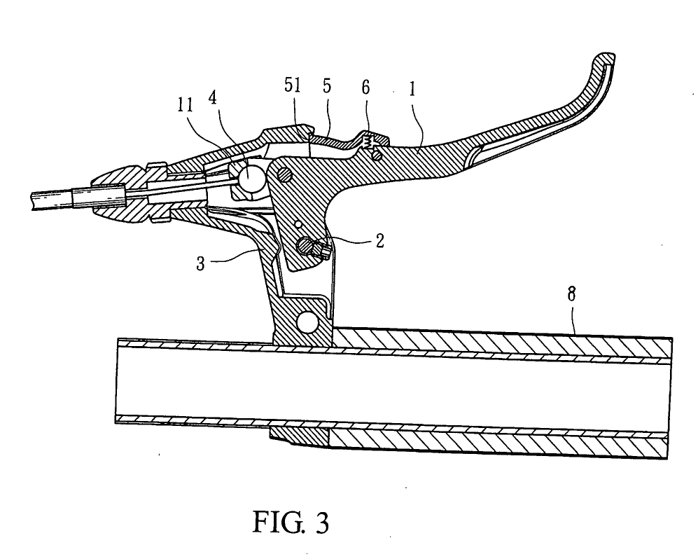

Referring to FIGS. 1 to 6, a brake operating device for a bicycle in accordance with a preferred embodiment of the invention comprises the following components as discussed in detail below.

A substantially T-shaped brake lever 1 comprises a hole-shaped cable connector 11 at one end of the transverse portion thereof with an enlargement 4 at one end of a brake cable 9 being retained therein. A lever return spring (e.g., torsion spring) 21 and a pivot pin 2 are employed to rotatably mount one end of the longitudinal portion of the brake lever 1 in a housing 3. Also, the brake cable 9 passes through an open space 32 of the housing 3 to connect to a brake pad (not shown) of, for example, a caliper brake (not shown). A recess 31 is formed at an upper edge of the mouth of the space 32. A helical spring 6 and a pivot pin 7 are employed to pivotably mount one end of a stop member 5 on a portion proximate to a joining point of the transverse and longitudinal portions of the brake lever 1. The stop member 5 substantially has a longitudinal section of U so as to sit upon the brake lever 1. An abutment 51 at the other end of the stop member 5 is urged against the recess 31 (i.e., locked) when the brake lever 1 is installed on the housing 3 which is mounted on a handlebar 8.

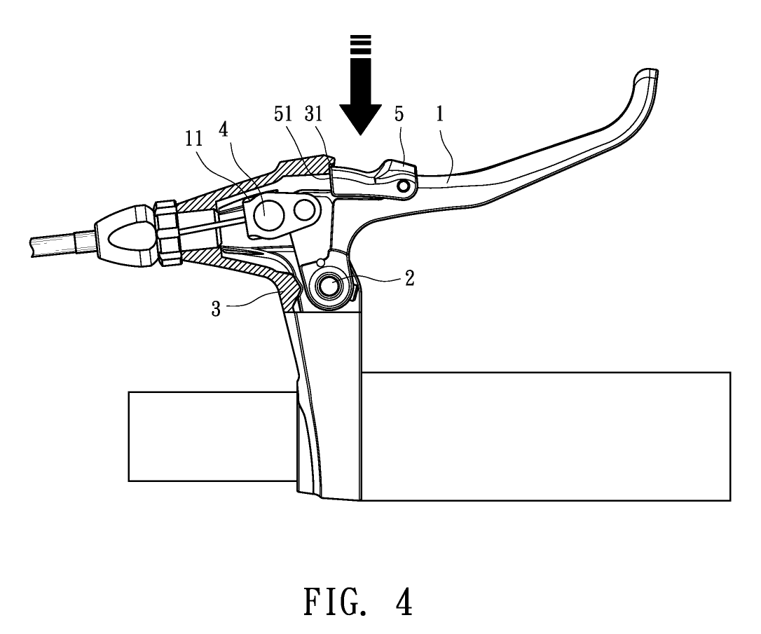

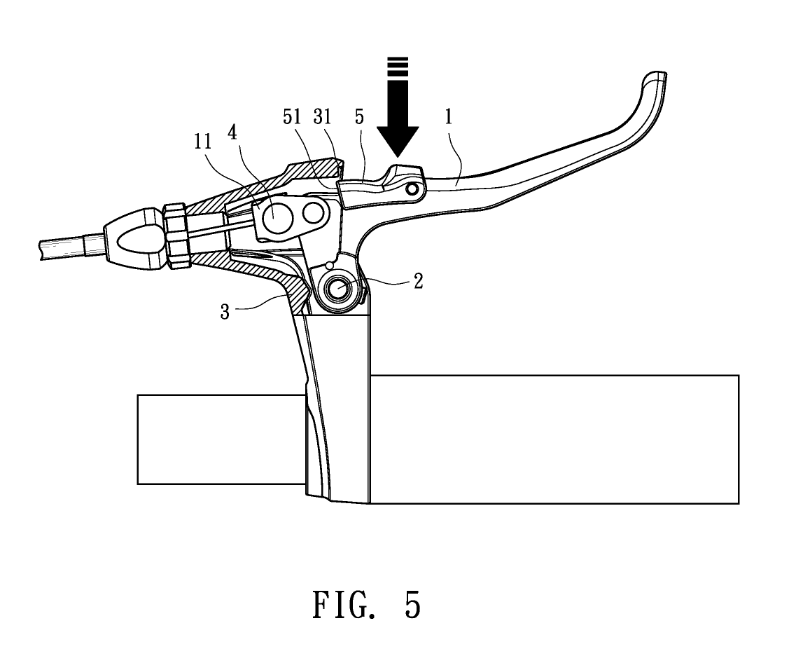

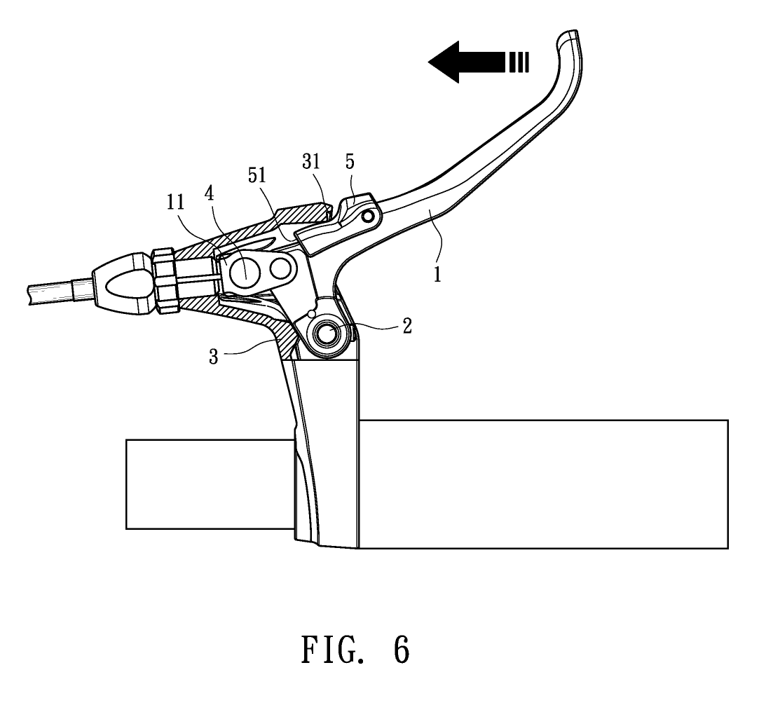

A brake cable loosening operation of the invention will be described in detail below. First, press the front and/or intermediate portions of the stop member 5 until the abutment 51 is not blocked by the recess 31 (see FIGS. 4 and 5). That is, the stop member 5 is unlocked. Next, pivot the brake lever 1 about the pivot pin 2 as indicated by arrow in FIG. 6. The pivoting will be stopped when the cable connector 11 contacts an internal shoulder (not numbered) of the space 32 adjacent a cable channel (not numbered). As a result, the brake cable 9 is loosened. Also, brake pad (not shown) is loosened. Thereafter, a bicycle mechanic can easily remove a broken wheel for replacement or repair.

While the invention herein disclosed has been described by means of specific embodiments, numerous modifications and variations could be made thereto by those skilled in the art without departing from the scope and spirit of the invention set forth in the claims.

What is claimed is:

1. A brake operating device for a bicycle, comprising:
a housing on a handlebar, the housing comprising a recess on a mouth;
a spring biased brake lever rotatably mounted on the housing;
a brake cable having one end connected to a cable connector of the brake lever; and
a spring biased stop member pivotably sitting upon the brake lever to urge against the recess,
whereby pressing the stop member to disengage the stop member from the recess and counterclockwise pivoting the brake lever will loosen the brake cable.
